(19) United States
(12) Patent Application Publication
(10) Pub. No.: US 2022/0253198 A1
(43) Pub. Date: Aug. 11, 2022

(54) IMAGE PROCESSING DEVICE, IMAGE PROCESSING METHOD, AND RECORDING MEDIUM

(71) Applicant: SONY CORPORATION, Tokyo (JP)

(72) Inventors: TSUYOSHI ISHIKAWA, TOKYO (JP); TOMOHIRO OOI, TOKYO (JP); KYOSUKE YAMAZAKI, TOKYO (JP); YASUSHI IKEDA, TOKYO (JP)

(21) Appl. No.: 17/627,954

(22) PCT Filed: Jul. 16, 2020
(86) PCT No.: PCT/JP2020/027632

§ 371 Date: Jan. 18, 2022

(30) Foreign Application Priority Data
Jul. 30, 2019 (JP) 2019-139687

(51) Int. Cl. G06F 3/04815; G06F 3/0488; H04N 5/222; H04N 5/232

(52) U.S. Cl. CPC G06F 3/04815; H04N 5/23299; H04N 5/2224; G06F 3/0488

(57) ABSTRACT

The present technology relates to an image processing device, image processing method, and recording medium capable of improving operability for a user.

Provided is an image processing device including an image processing unit that disposes, in a virtual space, a virtual camera of three-dimensional virtual space, performs control so that the display terminal displays a background image representing the virtual space and a virtual object disposed in the background image, determines pitch rotation of the display terminal on the basis of a measurement signal measured by the display terminal, causes the virtual camera to rotate in a pitch direction around the virtual object on the basis of a determination result of the pitch rotation of the display terminal, determines touch operation on a touch panel of the display terminal, and causes the virtual camera to rotate in a yaw direction around the virtual object in the virtual space on the basis of a determination result of the touch operation. The present technology can be applied to, for example, a mobile terminal.

### TECHNICAL FIELD

The present technology relates to an image processing device, an image processing method, and a recording medium, and more particularly to an image processing device, image processing method, and recording medium capable of improving operability for a user.

### BACKGROUND ART

There is known a technique for generating a virtual three-dimensional space, setting a viewpoint (virtual camera position) in the three-dimensional space, and displaying the three-dimensional space, which is viewed from the virtual camera position, as a 3D image (refer to Patent Documents 1 to 3).

### CITATION LIST

### Patent Document

Patent Document 1: WO 2009/084213
Patent Document 2: Japanese Patent Application Laid-Open No. 2003-334379
Patent Document 3: Japanese Patent Application Laid-Open No. 2002-298160

### SUMMARY OF THE INVENTION

### Problems to be Solved by the Invention

By the way, when observing an observation target in a three-dimensional virtual space, it is required to enable intuitive movement of a virtual camera with respect to the observation target to enhance operability for a user.

The present technology has been developed in view of the above circumstances, and is to improve operability of a user.

### Solutions to Problems

An image processing device according to one aspect of the present technology includes an image processing unit that disposes, in a three-dimensional virtual space, a virtual camera that specifies an area in the virtual space, the area being displayed by a display terminal, performs control so that the display terminal displays a background image representing the virtual space and a virtual object disposed in the background image, determines pitch rotation of the display terminal on the basis of a measurement signal measured by the display terminal, causes the virtual camera to rotate in a pitch direction around the virtual object on the basis of a determination result of the pitch rotation of the display terminal, determines touch operation on a touch panel of the display terminal, and causes the virtual camera to rotate in a yaw direction around the virtual object in the virtual space on the basis of a determination result of the touch operation.

An image processing method according to one aspect of the present technology includes, by an image processing device, disposing, in a three-dimensional virtual space, a virtual camera that specifies an area in the virtual space, the area being displayed by a display terminal, performing control so that the display terminal displays a background image representing the virtual space and a virtual object disposed in the background image, determining pitch rotation of the display terminal on the basis of a measurement signal measured by the display terminal, causing the virtual camera to rotate in a pitch direction around the virtual object on the basis of a determination result of the pitch rotation of the display terminal, determining touch operation on a touch panel of the display terminal, and causing the virtual camera to rotate in a yaw direction around the virtual object in the virtual space on the basis of a determination result of the touch operation.

A recording medium according to one aspect of the present technology is recorded with a program for causing a computer to function as an image processing unit that disposes, in a three-dimensional virtual space, a virtual camera that specifies an area in the virtual space, the area being displayed by a display terminal, performs control so that the display terminal displays a background image representing the virtual space and a virtual object disposed in the background image, determines pitch rotation of the display terminal on the basis of a measurement signal measured by the display terminal, causes the virtual camera to rotate in a pitch direction around the virtual object on the basis of a determination result of the pitch rotation of the display terminal, determines touch operation on a touch panel of the display terminal, and causes the virtual camera to rotate in a yaw direction around the virtual object in the virtual space on the basis of a determination result of the touch operation.

In an image processing device, image processing method, and recording medium according to one aspect of the present technology, in a three-dimensional virtual space, a virtual camera that specifies an area in the virtual space is disposed, the area being displayed by a display terminal, control is performed so that the display terminal displays a background image representing the virtual space and a virtual object disposed in the background image, pitch rotation of the display terminal is determined on the basis of a measurement signal measured by the display terminal, the virtual camera is caused to rotate in a pitch direction around the virtual object on the basis of a determination result of the pitch rotation of the display terminal, touch operation on a touch panel of the display terminal is determined, and the virtual camera is caused to rotate in a yaw direction around the virtual object in the virtual space on the basis of a determination result of the touch operation.

Note that an image processing device according to one aspect of the present technology may be an independent device or may be an inner block including one device.

### BRIEF DESCRIPTION OF DRAWINGS

FIG. 1 is a diagram for describing pitch rotation and yaw rotation in a screen tilt system.

FIG. 2 is a diagram for describing a viewpoint with a hybrid system.

FIG. 3 is diagram illustrating movement of a fingertip in X and Y directions in screen touch operation.

FIG. 4 is a diagram illustrating a middle point and distance between two fingertips in the screen touch operation.

FIG. 5 is a diagram illustrating pitch rotation and yaw rotation in screen tilt operation.

FIG. 6 is a diagram illustrating relations among a virtual camera disposed in a virtual space, rotation in a pitch direction around a virtual object, and rotation in a yaw direction around a virtual object.

FIG. 7 is a diagram illustrating an example of a configuration of a 3D image display system to which the present technology is applied.

FIG. 8 is a diagram illustrating an example of a hardware configuration of a display terminal in FIG. 7.

FIG. 9 is a diagram illustrating an example of a functional configuration of the display terminal in FIG. 8.

FIG. 10 is a flowchart describing a flow of display processing.

FIG. 11 is a flowchart describing a flow of image processing corresponding to operation by a user.

FIG. 12 is a diagram illustrating a relation between a world coordinate system and virtual camera coordinates.

FIG. 13 is a diagram illustrating correspondence between screen touch operation and screen tilt operation in a novel system, and movement of the virtual camera.

FIG. 14 is a diagram illustrating an example of a configuration of a computer.

### MODE FOR CARRYING OUT THE INVENTION

Hereinafter, an embodiment of the present technology will be described with reference to the drawings. Note that the description will be made in the following order.

1. Embodiment of the present technology

2. Modifications

3. Configuration of computer

<1. Embodiment of the Present Technology>

As a user interface (UI) for observing a virtual object displayed together with a background image in a three-dimensional virtual space, there is a system for moving a virtual camera around an observation target. Examples of this system include a screen tilt system and a screen touch system.

The screen tilt system is a system for causing a virtual camera to revolve around an observation target by tilt of a screen of a display terminal such as a smartphone. The screen touch system is a system for moving a virtual camera position by touch operation on a screen of a display terminal. Moreover, there is also a hybrid system in which the screen tilt system and the screen touch system are combined.

In the screen tilt system, pitch rotation of the display terminal corresponds to pitch rotation of a hand of a user, the hand holding the display terminal (pitch rotation of a wrist). In a case where the screen tilt system is used, orientation of the virtual camera is basically linked to orientation of the display terminal, unlike a case where the screen touch system is used.

Therefore, with the screen tilt system, the orientation of the virtual camera can be intuitively recognized, and erroneous recognition (erroneous operation) of a rotation direction as in a case of using the screen touch system is less likely to occur. Therefore, from a viewpoint of observation of the virtual object disposed in a virtual space, the screen tilt system can provide the user with more intuitive operation as compared with the case of using the screen touch system.

Furthermore, with the screen tilt system, rotation (revolution around the virtual object) of the virtual camera in a pitch direction is performed in response to a pitch rotation signal output from a terminal tilt detector (such as an inertial measurement unit (IMU)). At this time, if the user moves only the wrist, the screen of the display terminal does not face the user due to the pitch rotation of the display terminal held in the hand.

If the screen is directed upward or downward by the pitch rotation of the display terminal, the user naturally adjusts own posture similarly to daily movement of looking into or looking up at a real object, so that the screen faces (a face of) the user.

More specifically, if the display terminal is subjected to the pitch rotation by movement of the wrist of the user, the user adjusts a position of the hand itself with pitch rotation of an arm, and further rotates a head with pitch rotation at the same time, so as to maintain a state where the screen of the display terminal faces the user.

That is, difficulty in viewing the screen due to the pitch rotation of the display terminal may be reduced by a natural daily movement of the user.

With respect to yaw rotation of the display terminal, the user can achieve maintenance of the screen facing the user by adjusting the position of the own hand with yaw rotation of the arm, and further performing yaw rotation of the head at the same time.

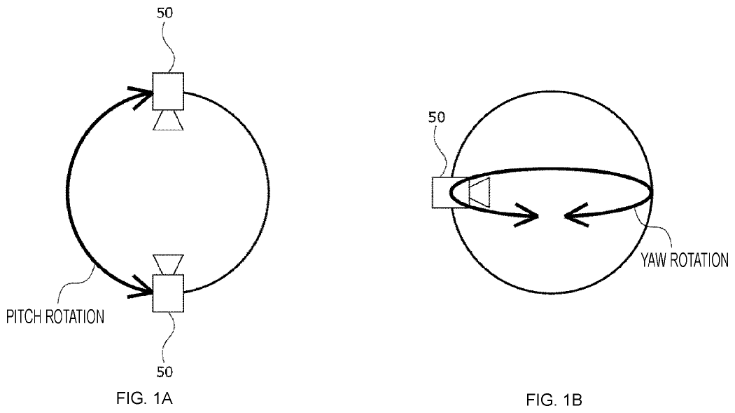

Here, a rotation amount in pitch rotation and yaw rotation in the screen tilt system will be considered. The pitch rotation is rotation for looking from above into or looking up from below at an observation target (virtual object). Therefore, an angle by which the observation target is desired to be rotated is +90 degrees as a maximum value and −90 degrees as a minimum value. Therefore, the user is only required to be able to operate a virtual camera 50 within a range of 180 degrees with respect to a pitch rotation angle of the wrist (A of FIG. 1).

Meanwhile, in the yaw rotation, in order to view the observation target from both front and rear, it is necessary to rotate the observation target by +180 degrees as the maximum value and −180 degrees as the minimum value, which is 360 degrees in total. Therefore, the virtual camera 50 is only required to be able to rotate by 360 degrees with respect to a yaw rotation angle of the wrist of the user (B of FIG. 1).

However, in a case where the user tries to perform such rotation with the display terminal, the user faces completely backward, and physical load increases. Furthermore, in an environment viewed by another person, such behavior of the user may be regarded as suspicious behavior.

In practice, it is also possible to achieve yaw rotation of the virtual camera with a little yaw rotation of the wrist by multiplying a yaw rotation amount of the wrist of the user by a predetermined coefficient. However, the virtual camera is difficult to be stabilized, because the virtual camera moves with a little movement of the wrist. Therefore, use in combination with the screen touch system, which will be described next, is common.

In the screen touch system, drag operation in a vertical direction on a touch panel of the display terminal is converted into rotation of the virtual camera in the pitch direction, and drag operation in a transverse direction on the touch panel of the display terminal is converted into rotation of the virtual camera in the yaw direction. Here, it is only required to drag by an amount desired to rotate the virtual camera, and the virtual camera is fixed at the position, and therefore the virtual camera can be accurately moved to a desired position.

Note that, with the screen tilt system, the virtual camera position is always changed by reflecting tilt of the screen, and the virtual camera position is not fixed. Furthermore, accuracy of position designation is often lower in the screen tilt system than in the screen touch system performed with a fingertip.

As a matter of course, with the screen touch system, the virtual camera position cannot be changed unless the user touches the screen with the fingertip. Although this may not be a problem depending on use application, in a train, it is difficult to move a virtual camera in a situation where one hand holds a display terminal such as a smartphone, and another hand holds a handrail.

Therefore, viewing/listening experience in a situation where the user cannot use both hands can be improved if it is possible to provide an operation method that enables operation with the user moving hands as little as possible, that is, with less physical load on the user.

Currently, with a hybrid system, operation of yaw rotation and pitch rotation by tilting a screen of a display terminal, and operation of yaw rotation and pitch rotation by touching the screen are enabled.

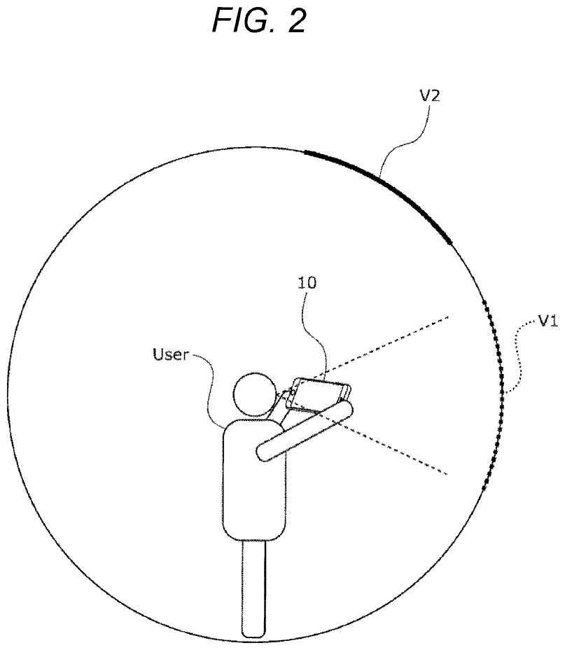

However, in a case where a position of the virtual camera is changed in the pitch direction by drag operation in the vertical direction at a time of touch operation on the screen of the display terminal, the sky above, ground below, or the like is inevitably visible from the user even if the user holds the screen of the display terminal right in front in a horizontal direction, by which the user may be confused as to which direction a viewpoint is facing (FIG. 2).

FIG. 2 schematically illustrates a state where the user looking at a screen of a display terminal 10 in a real space views not an image V1 desired to be viewed in the virtual space, but an image V2 of above (such as the sky) in a case where a viewpoint of the user exists at the virtual camera position in the virtual space represented by a circle in the drawing.

Here, characteristics of the above-described screen tilt system, screen touch system, and hybrid system are summarized as follows.

Examples of advantages (pros) of the screen tilt system are the following points. First, the user can intuitively perform operation with movement similar to daily movement of looking into or looking up at a real object. Second, because the user can operate the display terminal only with one hand, physical load is low in a case where a rotation angle of the pitch rotation or yaw rotation is shallow.

Meanwhile, a disadvantage (cons) of the screen tilt system is that as the rotation angle of the pitch rotation and yaw rotation increases, the physical load on the user at a time of viewing/listening also increases.

An advantage (pros) of the screen touch system is that the virtual camera position can be accurately moved from a current position to a desired position in the virtual space.

Meanwhile, a disadvantage (cons) of the screen touch system is that the user cannot move the virtual camera unless touching the screen of the display terminal with a fingertip, and therefore, physical load is applied due to the touch operation.

Examples of advantages (pros) of the hybrid system are the following points. First, because the user can operate the display terminal only with one hand as similar to the case of the screen tilt system, physical load is low in a case where a rotation angle is shallow.

Second, as similar to the case of the screen touch system, the virtual camera position can be accurately moved from a current position to a desired position in the virtual space. Third, unless performing a change in the pitch rotation with a screen touch, the user can perform intuitive operation with movement similar to daily movement of looking into or looking up at the real object.

Meanwhile, a disadvantage (cons) of the hybrid system is that, because not only screen tilt operation but also screen touch operation can be performed, an image with tilt different from the tilt of the screen of the display terminal may be displayed (FIG. 2).

Therefore, in a system to which the present technology is applied (hereinafter, referred to as a novel system), the virtual camera is rotated in the yaw direction by operation of touching the screen at a time of screen touch operation, and is rotated in the pitch direction and yaw direction by tilt of the screen at a time of screen tilt operation, by which the virtual camera position with respect to the virtual object is changed.

With this arrangement, it is possible to avoid the user from being confused by occurrence of upside down or the like due to screen display with tilt different from tilt of the screen of the display terminal, and is possible to perform more intuitive operation to move the virtual camera around the observation target (virtual object). As a result, the operability for the user can be improved.

(Definition of Terms)

Here, before describing detailed content of the novel system, terms used in the present disclosure will be defined.

The “virtual camera” specifies an area displayed by (a screen of) the display terminal in a three-dimensional virtual space. The virtual camera position in the virtual space corresponds to a position of a viewpoint of the user viewing the screen of the display terminal.

The “background image” is an image representing a three-dimensional virtual space. The background image includes a wide-angle image having a viewing angle of at least 180 degrees or wider. The “virtual object” is an object (object) disposed in a background image.

The virtual object is an observation target observed by the user. Although the virtual object varies depending on provided service, and an athlete, a celebrity, or the like that the user wishes to focus on is the observation target. The virtual object to be observed is not limited to a person, and may be a living thing (such as a dog, a cat, or an insect), an object (such as art), or the like. Furthermore, the number of virtual objects to be observed is not limited to one and may be more than one, and moreover, the virtual object may not be necessarily stationary, and may be moving.

Note that a space in real life, which is opposite to the “virtual space”, is referred to as a “real space”. Furthermore, an object in real life, which is opposite to the “virtual object”, is referred to as a “real object”.

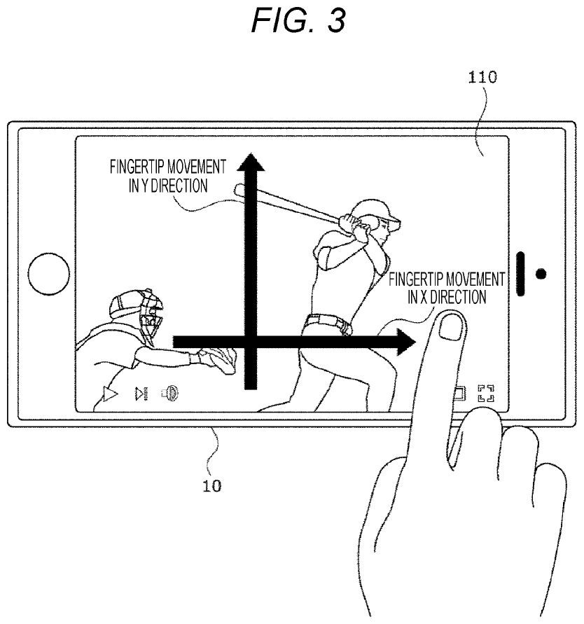

“Fingertip movement in X direction” and “fingertip movement in Y direction” at a time of screen touch operation represent operations as illustrated in FIG. 3. It is provided however that FIG. 3 illustrates a case where the screen of the display terminal 10 is in a landscape orientation.

The “fingertip movement in X direction” is operation of moving a finger of the user in the horizontal direction (X direction) in a state where the finger is in contact with a screen of a touch panel 110 of the display terminal 10 (the arrow pointing the horizontal direction in FIG. 3). The “fingertip movement in Y direction” is operation of moving the finger of the user in a perpendicular direction (Y direction) in a state where the finger is in contact with the screen of the touch panel 110 (the arrow pointing the perpendicular direction in FIG. 3).

Note that the “fingertip movement in X direction” and the “fingertip movement in Y direction” may be not only movement of a fingertip of one finger of the user, the fingertip being on the screen illustrated in FIG. 3, but also movement of fingertips of two or more fingers (such as an index finger and middle finger) that are in contact with the screen at the same time.

Furthermore, although FIG. 3 illustrates operation from a left side toward a right side in the drawing as movement in the horizontal direction, the movement in the horizontal direction may also be operation from the right side toward the left side in the drawing. Furthermore, although FIG. 3 illustrates operation from a lower side toward an upper side in the drawing as movement in the perpendicular direction, the movement in the perpendicular direction may also be operation from the upper side toward the lower side in the drawing.

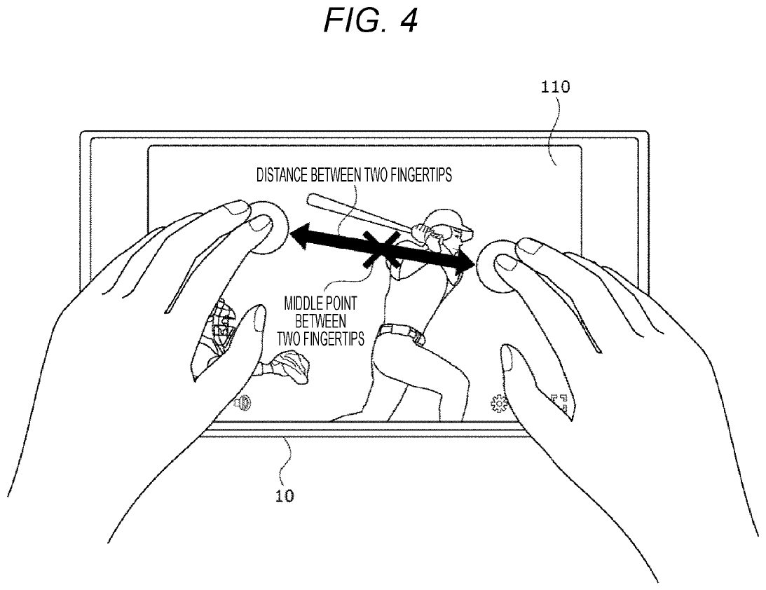

Furthermore, “distance between two fingertips” and “middle point between two fingertips” at a time of screen touch operation represent operations as illustrated in FIG. 4. It is provided however that FIG. 4 illustrates a case where the screen of the display terminal 10 is in the landscape orientation.

The “distance between two fingertips” is a distance between two fingertips of the user, the fingertips being in contact with the screen of the touch panel 110 (the arrow in FIG. 4). The “middle point between two fingertips” is a position of a middle point between the two fingertips of the user, the fingertips being in contact with the screen of the touch panel 110. In other words, it can also be said that the “middle point between two fingertips” is an intermediate position (the cross mark on the arrow in FIG. 4) of the “distance between two fingertips”.

Note that although FIG. 4 exemplifies a case where the “distance between two fingertips” is a distance between the fingertips of index fingers of left and right hands of the user, the distance may be a distance between fingertips of two fingers (such as an index finger and a middle finger) of one hand.

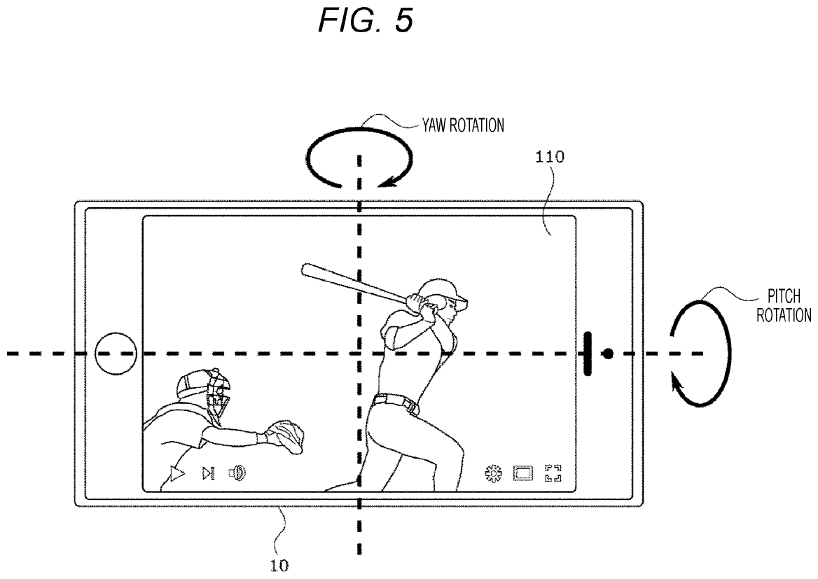

“Pitch rotation” and “yaw rotation” in the screen tilt operation represent rotations as illustrated in FIG. 5. It is provided however that FIG. 5 illustrates a case where the screen of the display terminal 10 is in the landscape orientation.

The “pitch rotation” indicates rotation in the vertical direction with a transverse direction in the drawing (the broken line in the horizontal direction) as an axis (FIG. 5). Specifically, as illustrated in FIG. 5, in a case where the screen of the display terminal 10 such as a smartphone is in the landscape orientation, rotation in the vertical direction with a longer direction as an axis is referred to as pitch rotation.

The “yaw rotation” indicates rotation in the transverse direction with the vertical direction in the drawing (the broken line in the perpendicular direction) as an axis (FIG. 5). Specifically, as illustrated in FIG. 5, in a case where the screen of the display terminal 10 is in the landscape orientation, rotation in the transverse direction with a direction perpendicular to the longer direction (shorter direction) as an axis is referred to as yaw rotation.

Note that, although not illustrated, in a case where the screen of the display terminal 10 is in a vertical orientation, rotating in the vertical direction with the shorter direction as an axis is referred to as “pitch rotation”, and rotating in the transverse direction with the longer direction as an axis is referred to as “yaw rotation”.

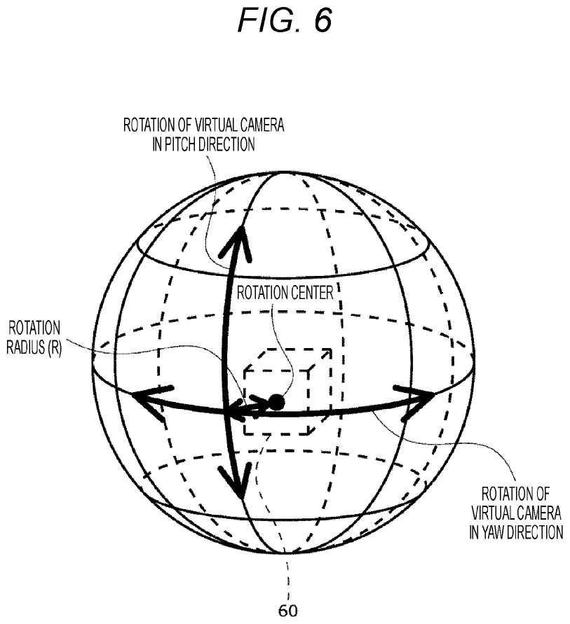

“Rotation in the pitch direction” and “rotation in the yaw direction” of the virtual camera in the virtual space indicate rotations as illustrated in FIG. 6.

The “rotation of the virtual camera in the pitch direction” indicates that the virtual camera moves on a Y-Z plane along a surface (spherical surface) of a sphere centered on a virtual object 60 (FIG. 6).

The “rotation of the virtual camera in the yaw direction” indicates that the virtual camera moves on an X-Z plane along the spherical surface of the sphere centered on the virtual object 60 (FIG. 6).

That is, it can also be said that the “rotation of the virtual camera in the pitch direction” and the “rotation of the virtual camera in the yaw direction” represent revolution of the virtual camera around the virtual object 60. When the virtual camera revolves around the virtual object 60 as the observation target, movement of viewpoint rotating around the virtual object 60 while looking at the virtual object 60 is enabled as a position of the viewpoint of the user.

In FIG. 6, a center (such as a center of gravity) of the virtual object 60 is set as a “rotation center (rotation center position)” of the virtual camera, and a distance from the rotation center to the virtual camera is set as a “rotation radius (R)”.

Note that, in the present disclosure, the “drag operation” is operation of moving a finger to a target location while keeping the finger in contact with the screen of the display terminal 10, and then releasing the finger. “Pinch-in operation” is operation of moving two fingers in a pinching motion on the screen of the display terminal 10 to reduce the screen. “Pinch-out operation” is operation of moving two fingers in a spreading motion on the screen of the display terminal 10 to enlarge the screen.

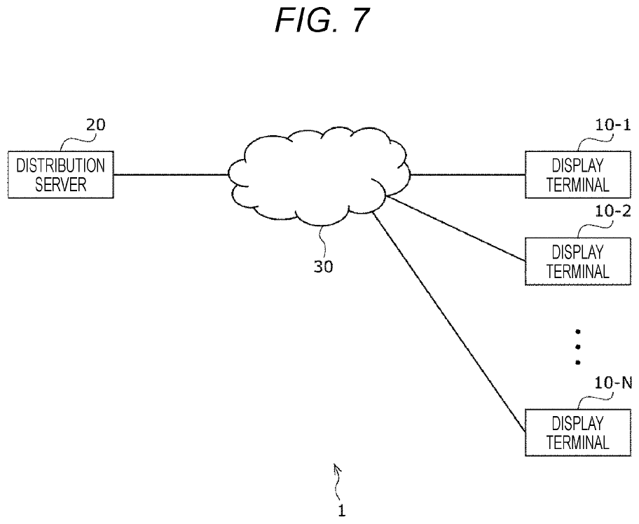

Hereinafter, the detailed content of the novel system will be described with reference to FIGS. 7 to 13.

(Configuration of System)

FIG. 7 illustrates an example of a configuration of a 3D image display system 1 compatible with the novel system.

The 3D image display system 1 includes display terminals 10-1 to 10-N (N: an integer of 1 or more), and a distribution server 20.

In the 3D image display system 1, the display terminals 10-1 to 10-N and the distribution server 20 are mutually connected via a network 30. The network 30 includes a communication network such as the Internet, an intranet, or a mobile telephone network.

The display terminal 10-1 is a mobile terminal having a display, such as a smartphone, a tablet terminal, a wearable device, or a portable game machine.

In response to operation by the user, or the like, the display terminal 10-1 transmits a distribution request for an application to the distribution server 20 via the network 30. The display terminal 10-1 receives the application distributed from the distribution server 20 via the network 30.

The application is software for viewing and listening a 3D image of an athlete, a celebrity, a character (avatar) in computer graphics, or the like, whose image is captured in a free-viewpoint video on the basis of 3D data. Hereinafter, the application is also referred to as a “3D application”.

The 3D data may be distributed in the 3D application, or the display terminal 10-1 may receive (dynamically load) the 3D data from an external server such as the distribution server 20 via the network 30 when the 3D application is executed.

In the display terminal 10-1, when the 3D application distributed from the distribution server 20 is executed, a 3D image is displayed on the basis of the 3D data.

The display terminals 10-2 to 10-N are configured as mobile terminals such as smartphones similarly to the display terminal 10-1. On each of the display terminals 10-2 to 10-N, when the 3D application distributed from the distribution server 20 is executed, a 3D image is displayed.

Note that, in the following description, the display terminals 10-1 to 10-N will also be simply referred to as a “display terminal 10” in a case where the display terminals are not particularly necessary to be distinguished from one another.

The distribution server 20 includes one or a plurality of servers for distributing the 3D application, and is installed in a data center or the like. The distribution server 20 is provided by a business operator or the like that provides a content service, such as a 3D image distribution service, as business.

The distribution server 20 transmits (distributes) the 3D application via the network 30 in response to the distribution request from the display terminal 10. Furthermore, in a case where the 3D data is not included in the 3D application, the distribution server 20 transmits (distributes) the 3D data via the network 30 in response to the distribution request from the display terminal 10.

(Configuration of Display Terminal)

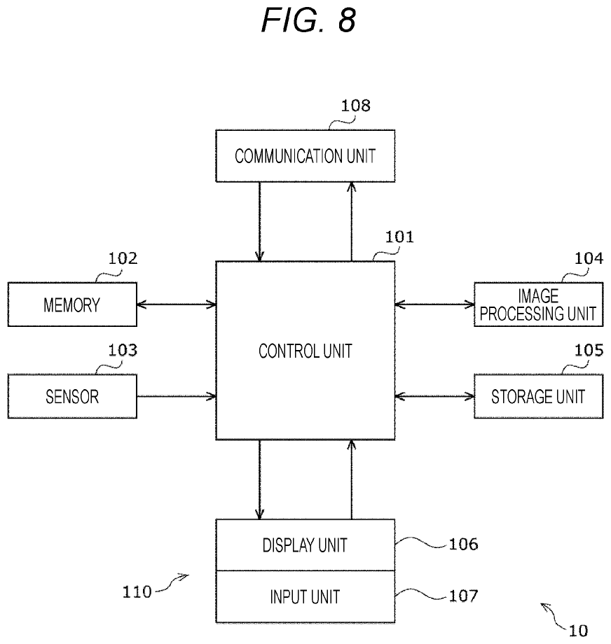

FIG. 8 illustrates an example of a hardware configuration of the display terminal 10 in FIG. 7.

In FIG. 8, the display terminal 10 includes a control unit 101, a memory 102, a sensor 103, an image processing unit 104, a storage unit 105, a display unit 106, an input unit 107, and a communication unit 108. In the display terminal 10, the display unit 106 and the input unit 107 constitute the touch panel 110.

The control unit 101 includes a processor such as a central processing unit (CPU). The control unit 101 is a main control device (processing device) that controls operation of each unit and performs various arithmetic processing, and controls operation of each unit of the display terminal 10.

The memory 102 includes a semiconductor memory such as a random access memory (RAM). The memory 102 temporarily stores various data processed by the control unit 101.

The sensor 103 includes various sensor devices. The sensor 103 performs sensing of the user, vicinity thereof, or the like, and supplies the control unit 101 with sensor data obtained as a result of the sensing. The control unit 101 performs various processing on the basis of the sensor data supplied from the sensor 103.

Examples of the sensor 103 include an inertial measurement unit (IMU) that measures three-dimensional angular velocity and acceleration, or the like. The inertial measurement unit (IMU) can obtain three-dimensional angular velocity and acceleration by a three-axis gyroscope and a three-direction accelerometer.

Note that the sensor 103 may include a proximity sensor that measures a thing in proximity, a biological sensor that measures information such as a heart rate, body temperature, or posture of a living thing, a magnetic sensor that measures a magnitude or direction of a magnetic field (magnetic field), or the like.

The image processing unit 104 includes a processor such as a graphics processing unit (GPU). The image processing unit 104 performs predetermined image processing on the 3D data or the like under control of the control unit 101. The display data obtained by the image processing is supplied to the display unit 106.

The storage unit 105 is an auxiliary storage device including a semiconductor memory such as a non-volatile memory. The storage unit 105 may be configured as an internal storage or may be an external storage such as a memory card.

The storage unit 105 records the 3D application or various data such as 3D data under control of the control unit 101. The control unit 101 can read and execute (data in) the 3D application recorded in the storage unit 105.

The display unit 106 and the input unit 107 constitute the touch panel 110. The display unit 106 is a display device such as a liquid crystal panel or an organic light emitting diode (OLED) panel. The input unit 107 is a position input device mounted on a surface of the display unit 106.

The display unit 106 displays a 3D image or various information corresponding to the display data from the image processing unit 104 under control of the control unit 101.

When a finger of the user comes in contact with (touches) the surface of the display unit 106, the input unit 107 supplies the control unit 101 with operation data corresponding to a contact position (position of a predetermined point). The control unit 101 performs various processing on the basis of the operation data supplied from the input unit 107.

The communication unit 108 is configured as a communication device (communication module) that supports wireless communication, such as wireless local area network (LAN) or cellular communication (for example, LTE-Advanced, 5G, or the like), or wired communication. The communication unit 108 communicates with another apparatus via the network 30 under control of the control unit 101.

The communication unit 108 transmits a distribution request for the 3D application or 3D data to the distribution server 20 via the network 30. The communication unit 108 receives the 3D application or 3D data distributed from the distribution server 20 via the network 30. The 3D application or 3D data is supplied to the image processing unit 104 and processed, or supplied to the storage unit 105 and recorded.

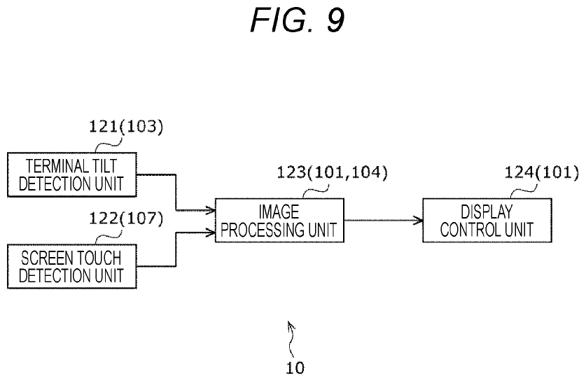

FIG. 9 illustrates an example of a functional configuration of the display terminal 10 (FIG. 8) configured as an image processing device to which the present technology is applied.

In FIG. 9, the display terminal 10 includes a terminal tilt detection unit 121, a screen touch detection unit 122, an image processing unit 123, and a display control unit 124.

The terminal tilt detection unit 121 corresponds to the sensor 103 (FIG. 8) including an inertial measurement unit (IMU) or the like. The terminal tilt detection unit 121 detects a tilt of the screen of the display terminal 10 and supplies the detection result to the image processing unit 123.

The screen touch detection unit 122 corresponds to the input unit 107 (FIG. 8) that constitutes the touch panel 110. The screen touch detection unit 122 detects contact (touch) on the surface of the display unit 106 by a finger of the user, and supplies the detection result to the image processing unit 123.

The image processing unit 123 corresponds to the control unit 101 (FIG. 8) and the image processing unit 104 (FIG. 8). The image processing unit 123 performs predetermined image processing on the basis of the 3D data received by the communication unit 108, and supplies the display control unit 124 with the display data obtained by the image processing.

The display control unit 124 corresponds to the control unit 101 (FIG. 8). The display control unit 124 performs control to display a 3D image on the display unit 106, the 3D image corresponding to the display data supplied from the image processing unit 123.

Here, by disposing the virtual camera in the virtual space and performing image processing for generating display data corresponding to the background image and virtual object, a 3D image including the background image and the virtual object is displayed on the screen of the display unit 106.

Furthermore, a detection result of the screen tilt from the terminal tilt detection unit 121 and a detection result of the screen touch from the screen touch detection unit 122 are supplied to the image processing unit 123.

The image processing unit 123 sets a parameter for moving the virtual camera disposed in the virtual space on the basis of at least either of the detection result of the screen tilt or the detection result of the screen touch. By setting this parameter, the virtual camera is moved in the virtual space.

The 3D image display system 1 is configured as described above.

Note that the above-described configuration is an example of the configuration of the 3D image display system 1 or display terminal 10, and another component (such as an apparatus or function) may be added or an above-described component (such as an apparatus or function) may be eliminated.

For example, although a configuration has been described above in which the distribution server 20 is provided as an apparatus on a distribution side in the 3D image display system (FIG. 7), a server for image processing may be separately provided, and 3D data subjected to image processing by the server may be distributed by the distribution server 20. Furthermore, the display terminal 10 may display a 3D image on the basis of not only the 3D application or 3D data distributed from the distribution server 20 but also the 3D application or 3D data recorded in the storage unit 105.

Furthermore, for example, although a configuration has been described above in which the image processing unit 104 is provided as the display terminal 10 (FIG. 8) other than the control unit 101, a function of the image processing unit 104 may be included in a function of the control unit 101 by integrating the control unit 101 and the image processing unit 104 (configured as a system-on-a-chip, or the like).

Furthermore, for example, a speaker, a camera, a near-field wireless communication unit, or the like may be included as a component of the display terminal 10 (FIG. 8). Specifically, in the display terminal 10, the speaker outputs audio (sound) related to 3D image corresponding to 3D data under control of the control unit 101.

The camera includes an optical system, an image sensor, a signal processing circuit, or the like, and supplies the control unit 101 with imaging data obtained by capturing an image of a subject such as the user. The control unit 101 performs various processing on the basis of the imaging data from the camera. The near-field wireless communication unit is configured as a communication device that supports near-field wireless communication such as Bluetooth (registered trademark). The near-field wireless communication unit performs near-field wireless communication with another apparatus under control of the control unit 101.

(Flow of Display Processing)

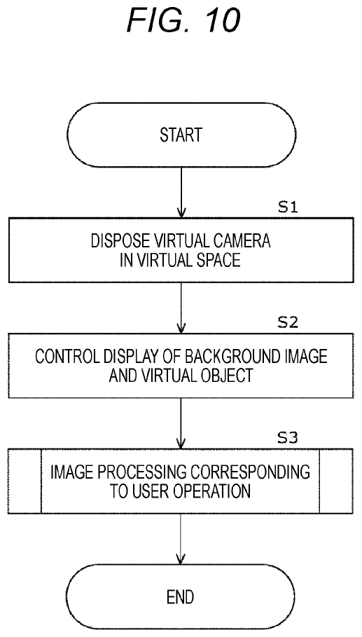

Next, a flow of display processing compatible with the novel system executed by the display terminal 10 will be described with reference to a flowchart in FIG. 10.

In Step S1, the image processing unit 123 performs predetermined image processing on the basis of the 3D data, and disposes the virtual camera in a three-dimensional virtual space.

In Step S2, on the basis of the result of the image processing, the display control unit 124 controls display of a background image representing the three-dimensional virtual space and the virtual object disposed in the background image.

With this arrangement, the display terminal 10 displays, on the screen of the display unit 106, the 3D image including the virtual object with the background image as a background when viewed from the virtual camera position corresponding to the position of the viewpoint of the user.

In Step S3, the image processing unit 123 performs image processing corresponding to operation by the user. In this image processing, a parameter for moving the virtual camera position in the virtual space is set at a position corresponding to screen touch operation or screen tilt operation by the user, and the virtual camera position is moved according to the parameter.

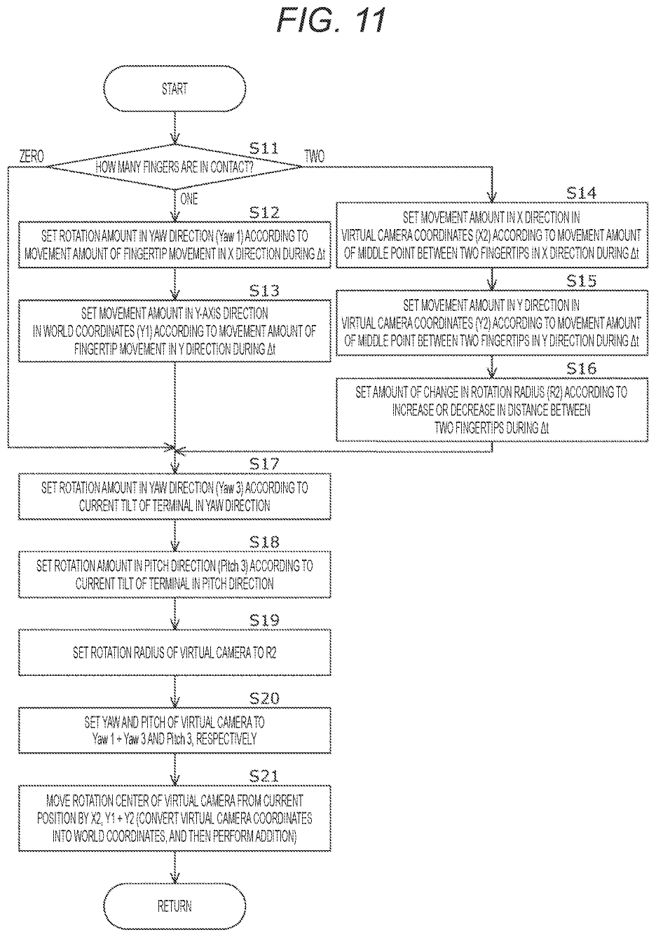

Here, with reference to the flowchart in FIG. 11, a flow of image processing in response to the operation by the user that corresponds to processing in Step S3 in FIG. 10 will be described.

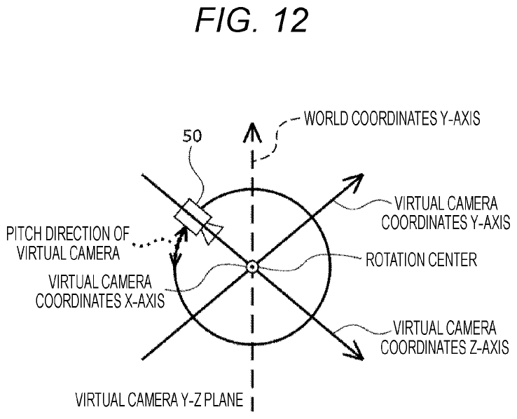

Note that a coordinate system used in this image processing includes world coordinates that are coordinates representing a world in the three-dimensional space itself in the virtual space, and virtual camera coordinates that are coordinates unique to the virtual camera. FIG. 12 illustrates a relation between the world coordinates and the virtual camera coordinates.

In FIG. 12, a case is assumed where the virtual camera 50 rotates in the pitch direction on the virtual camera Y-Z plane including a virtual camera coordinates Y-axis and a virtual camera coordinates Z-axis with an origin point of XYZ-axes in the virtual camera coordinates as a center of the rotation. In this case, among XYZ-axes in the world coordinates, a world coordinates Y-axis is represented by a broken line in a direction from a lower side toward an upper side in the drawing.

That is, as the only absolute coordinates (coordinates not affected by the virtual camera position (by the position of the viewpoint of the user)) in the virtual space, the world coordinates serve as an index of a display position (coordinates) of the virtual object or the like. Therefore, the world coordinates do not necessarily coincide with the virtual camera coordinates unique to the virtual camera, and in an example in FIG. 12, the world coordinates Y-axis and the virtual camera coordinates Y-axis have different axis orientations.

Returning to the description in FIG. 11, first, the image processing unit 123 performs screen touch operation processing corresponding to the number of fingers of the user in contact with the screen of the display unit 106 on the basis of a detection result detected by the screen touch detection unit 122.

In a case where it is determined in determination processing in Step S11 that the number of fingers detected by the screen touch detection unit 122 is one, processing in Steps S12 and S13 is executed.

That is, the image processing unit 123 sets a rotation amount in the yaw direction (hereinafter described as “Yaw 1”) according to a movement amount of the fingertip movement in X direction during Δt (S12).

Furthermore, the image processing unit 123 sets a movement amount in a Y-axis direction in the world coordinate system (hereinafter described as “Y1”) according to a movement amount of the fingertip movement in Y direction during Δt (S13).

In a case where it is determined in the determination processing in Step S11 that the number of fingers detected by the screen touch detection unit 122 is two, processing in Steps S14 to S16 is executed.

That is, the image processing unit 123 sets an amount of movement in an X direction in the virtual camera coordinates (hereinafter described as “X2”) according to an amount of movement of the middle point between two fingertips in the X direction during Δt (S14).

Furthermore, the image processing unit 123 sets an amount of movement in a Y direction in the virtual camera coordinates (hereinafter described as “Y2”) according to an amount of movement of the middle point between two fingertips in the Y direction during Δt (S15).

Furthermore, the image processing unit 123 sets an amount of change in a rotation radius (hereinafter described as “R2”) according to an increase or decrease in a distance between two fingertips during Δt (S16).

When the processing in Step S13 or S16 ends, the processing proceeds to Step S17. Furthermore, in a case where it is determined in the determination processing in Step S11 that the number of detected fingers is zero, screen touch operation processing corresponding to the number of fingertips is unnecessary, and therefore the processing proceeds to Step S17.

Next, the image processing unit 123 performs screen tilt operation processing corresponding to current tilt of the screen of the display terminal 10 on the basis of a detection result detected by the terminal tilt detection unit 121.

That is, the image processing unit 123 sets a rotation amount in the yaw direction (hereinafter described as “Yaw 3”) according to current tilt of the display terminal 10 in the yaw direction (S17).

Furthermore, the image processing unit 123 sets a rotation amount in the pitch direction (hereinafter referred to as “Pitch 3”) according to the current tilt of the display terminal 10 in the pitch direction (S18).

The image processing unit 123 sets a rotation radius of the virtual camera 50 to R2 (S19). Furthermore, the image processing unit 123 sets a rotation amount of the virtual camera 50 in the yaw direction around the virtual object and a rotation amount of the virtual camera 50 in the pitch direction around the virtual object to Yaw 1+Yaw 3 and Pitch 3, respectively (S20).

The image processing unit 123 sets a movement amount by which a rotation center of the virtual camera 50 is moved from the current position by X2, Y1+Y2 (S21). It is provided however that, at this time, the virtual camera coordinates (X2, Y2) are converted into the world coordinates, and then the addition is performed after Y1 and the coordinate system are matched.

In this manner, the image processing unit 123 sets parameters related to a rotation radius and rotation center of the virtual camera and rotation of the virtual camera in the pitch direction and the yaw direction (rotation radius R2, rotation center (X2, Y1+Y2), rotation amount in the pitch direction (Pitch 3), rotation amount in the yaw direction (Yaw 1+Yaw 3)), by which the virtual camera position is moved according to the parameters.

When the processing in Step S21 ends, the processing returns to Step S3 in FIG. 10, and the subsequent processing is executed.

The flow of the display processing compatible with the novel system has been described above. In this display processing, the position of the virtual camera 50 is changed in response to the operation by the user, by rotating the virtual camera 50 in the yaw direction in a case where screen touch operation is performed by the user, and by rotating the virtual camera 50 in the pitch direction and yaw direction in a case where screen tilt operation is performed by the user. Note that, at this time, an actual position of the display terminal 10 in the real space is not reflected in the movement of the virtual camera 50.

With this arrangement, it is possible to avoid the user from being confused by occurrence of upside down or the like due to screen display with tilt different from tilt of the screen of the display terminal 10, and is possible to perform more intuitive operation to move the virtual camera around the virtual object.

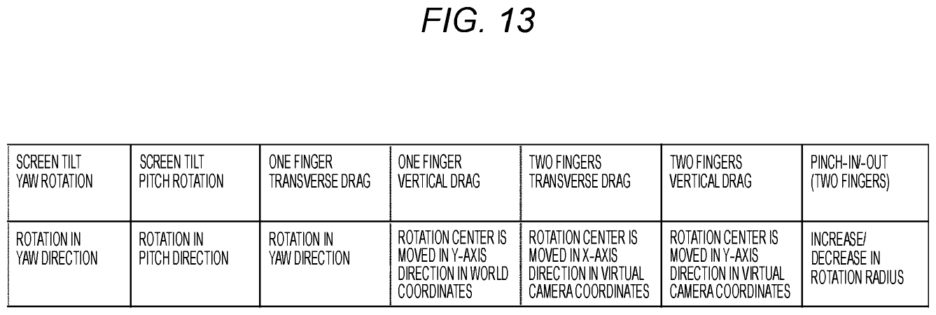

Here, correspondence between the screen touch operation and screen tilt operation, and movement of the virtual camera 50 in the above-described novel system is summarized as illustrated in FIG. 13.

In a case where tilt of the screen of the display terminal 10 is in a yaw rotation by screen tilt operation, the virtual camera 50 disposed in the virtual space rotates in the yaw direction around the virtual object according to the tilt of the screen (S17, S20 in FIG. 11).

Furthermore, in a case where tilt of the screen of the display terminal 10 is in a pitch rotation by screen tilt operation, the virtual camera 50 rotates in the pitch direction around the virtual object according to the tilt of the screen (S18, S20 in FIG. 11).

In a case where drag operation is performed in the transverse direction (horizontal direction) on the screen with one finger by screen touch operation, the virtual camera 50 rotates in the yaw direction around the virtual object according to an amount of movement of the fingertip (S12, S20 in FIG. 11).

Furthermore, in a case where drag operation in the vertical direction (perpendicular direction) is performed on the screen with one finger by screen touch operation, the rotation center of the virtual camera 50 is moved in the Y-axis direction in the world coordinates according to an amount of movement of the fingertip (S13, S21 in FIG. 11).

In a case where drag operation in the transverse direction (horizontal direction) is performed with two fingers by screen touch operation, the rotation center of the virtual camera 50 is moved in an X-axis direction on the virtual camera coordinates according to an amount of movement of the fingertips (S14, S21 in FIG. 11).

Furthermore, in a case where drag operation in the vertical direction (perpendicular direction) is performed with two fingers by screen touch operation, the rotation center of the virtual camera 50 is moved in a Y-axis direction in the virtual camera coordinates according to an amount of movement of the fingertips (S15, S21 in FIG. 11).

In a case where pinch-in operation is performed with two fingers by screen touch operation, a 50 rotation radius of the virtual camera increases (S16, S19 in FIG. 11). Meanwhile, in a case where pinch-out operation is performed with two fingers by screen touch operation, a rotation radius of the virtual camera 50 decreases (S16, S19 in FIG. 11).

<2. Modifications>

(Other Examples of Configuration)

Although a case has been described above where the display terminal 10 executes image processing (FIG. 11) corresponding to operation by the user, by which movement of the virtual camera 50 corresponding to screen touch operation and screen tilt operation in the novel system is achieved, image processing (FIG. 11) corresponding to operation by the user may be executed by another apparatus such as the distribution server 20.

Specifically, in the display terminal 10, the communication unit 108 transmits a result of detection by the terminal tilt detection unit 121 and the screen touch detection unit 122 to an external server, such as the distribution server 20, via the network 30, by which display data (or 3D data) in consideration of the detection result is generated in the external server. Then, when the external server transmits (distributes) the display data (or 3D data), the display terminal 10 can display, on the basis of the display data (or 3D data), a 3D image corresponding to the operation by the user.

Furthermore, a case has been exemplified above where the display terminal 10 displays a 3D image corresponding to 3D data by the distributed 3D application being executed, the display terminal 10 is only required to acquire 3D data or display data in some way, and the 3D application is not necessarily required.

Note that, in the present disclosure, the system means a set of a plurality of components (devices, modules (parts), or the like) without regard to whether or not all the components are in the same housing. Therefore, a plurality of devices housed in individual housings and connected via the network 30, and one device housing a plurality of modules in one housing are both systems.

(Example of Input Interface)

Although a case has been described above where an inertial measurement unit (IMU) that measures three-dimensional angular velocity and acceleration is used as an input interface for screen tilt operation, another input interface such as a pressure-sensitive sensor may be used.

Specifically, the pressure-sensitive sensor may be used to turn on/off detection of a screen tilt, and the virtual camera 50 may be rotated in the yaw direction or the pitch direction when the pressure-sensitive sensor is pressed in by pressure or the like corresponding to the contact by a finger of the user.

Furthermore, although a case has been described above where drag operation in the transverse direction or the vertical direction, or the like, by the user is detected by using the touch panel 110 as an input interface for screen touch operation, another input interface such as a controller or a remote controller may be used.

Specifically, a controller or the like may be connected to the display terminal 10, and, according to operation (such as left/right key operation or up/down key operation) of the controller, or the like, by the user, the virtual camera may be rotated in the yaw direction, or the rotation center of the virtual camera may be moved in the Y-axis direction in the world coordinate system.

Note that the input interface may be switched from the touch panel 110 to the controller or the like when screen touch is in an unstable state due to breakage of the touch panel 110 or the like at a time of screen touch operation.

(Examples of Initial Value and Restrictions)

Although an initial value and restriction regarding the virtual camera 50 are not particularly described in the above description, an initial value or restriction may be set for a movement region, rotation amount, rotational rate, or the like of the rotation radius or rotation center of the virtual camera 50.

Specifically, with respect to the movement region and rotation amount of the rotation radius or rotation center, it is possible to set in advance an area that can be used by the user, such as a size or movement region of the virtual object that is an observation target, an area from which three-dimensional data can be acquired, or a looking-in prohibition angle.

Furthermore, when the rotation radius, rotation center, rotation amount, or the like exceeds a predetermined limit value, feedback may be performed in a display mode different from a display mode for normal operation, by changing display (for example, displaying in red) of a predetermined region on the screen of the display unit 106 (for example, left or right end or upper or lower end of the screen). Note that, here, feedback may be performed not only by display but also by sound, vibration, or the like.

Furthermore, in the display terminal 10, in a case where a sudden shake, tilt, or the like of the screen, which is not intended at a time of normal operation, is detected, the detection result may be ignored on an assumption that the shake, tilt, or the like is not operation input by the user. Specifically, although it is assumed that the display terminal 10 such as a smartphone detects a certain vibration in a case where the user who uses the display terminal 10 gets on a vehicle such as an automobile or a train, the display terminal 10 can cancel the vibration.

(Examples of Screen Touch Operation)

As the above-described screen touch operation, in a case where drag operation in the vertical direction is performed with two fingers, and the rotation center of the virtual camera is moved in the Y-axis direction of the virtual camera according to an amount of movement of the fingertips, an angle of the virtual camera in the pitch direction may be set to 0 degrees (a state in which the virtual camera is facing front) or −90 degrees (a state in which the virtual camera is facing directly downward) for forcible transition to a predetermined state.

With this arrangement, the Y-axis direction in the virtual camera coordinates coincides with the Y-axis direction in the world coordinates, by which the rotation center of the virtual camera is moved in the vertical direction in the world coordinates, or the Y-axis direction in the virtual camera coordinates is parallel to the X-Z plane, by which the rotation center of the virtual camera is moved in the horizontal direction in the world coordinates, and therefore, the user can easily understand a direction in which the rotation center of the virtual camera is moved. Note that whether to set an angle of the virtual camera in the pitch direction to 0 degrees or −90 degrees can be determined by, for example, whether the angle of the virtual camera in the pitch direction at that time is closer to 0 degrees or −90 degrees.

Furthermore, as the above-described screen touch operation, the virtual camera may be (temporarily) rotated in the pitch direction when drag operation is performed in the vertical direction with one finger, and then the rotation in the pitch direction that has occurred by the drag operation may be restored to an original state at a predetermined timing, such as a moment when the user releases the finger from the screen after the drag operation. With this arrangement, it possible to substantially reduce rotation of the virtual camera in the pitch direction by drag operation in the vertical direction with one finger.

Furthermore, a button UI for changing the virtual object (rotation center) of the observation target observed by the user may be provided on the screen of the display terminal 10, and when the button UI is pressed, a predetermined virtual object at another position may be selected as the observation target to move the rotation center. Specifically, when the button UI is pressed in a case where the viewpoint of the user is focusing on a certain athlete, the viewpoint moves to a position of another athlete.

As described above, in the image processing unit (image processing unit 123) in the image processing device (such as the display terminal 10 or the distribution server 20) compatible with the novel system, pitch rotation and yaw rotation of the display terminal 10 are determined on the basis of a measurement signal (such as an IMU signal obtained by measurement of three-dimensional angular velocity and acceleration) measured by the display terminal 10, the virtual camera is rotated in at least either of the pitch direction or the yaw direction around the virtual object on the basis of a determination result of the pitch rotation and yaw rotation of the display terminal 10, touch operation on the touch panel 110 of the display terminal 10 is determined, and the virtual camera is rotated in the yaw direction around the virtual object in the virtual space on the basis of a determination result of the touch operation (for example, drag operation in the horizontal direction with one finger).

That is, the image processing unit of the image processing device compatible with the novel system does not reflect a determination result of touch operation (for example, drag operation with one finger in the perpendicular direction) in rotation of the virtual camera in the pitch direction in the virtual space. Furthermore, at this time, an actual position of the display terminal 10 in the real space is not reflected in the movement of the virtual camera.

With this arrangement, in the display terminal 10, the virtual camera is rotated in the yaw direction by operation of touching the screen at a time of screen touch operation, and is rotated in the pitch direction and yaw direction by tilt of the screen at a time of screen tilt operation, by which the virtual camera position with respect to the virtual object is changed. Therefore, it is possible to prevent screen display with tilt different from tilt of the screen, to avoid the user from being confused by occurrence of upside down or the like, and to perform more intuitive operation to move the virtual camera around the observation target (virtual object).

As a result, the operability for the user can be improved. Furthermore, the user can enjoy observing the virtual object as the observation target by moving the virtual camera with intuitive operation such as tilting the display terminal 10 or touching the screen.

Note that Patent Document 1 described above discloses a technique for moving a virtual camera in a case where acceleration and each velocity exceed predetermined threshold values. Furthermore, Patent Document 2 described above discloses a game system that displays a camera viewpoint video corresponding to tilt of a housing. However, Patent Documents 1 and 2 do not disclose a technique related to screen touch operation.

Furthermore, Patent Document 3 described above discloses a technique for moving a virtual camera according to displacement of XYZ-axes (IMU signal). However, although disclosing movement of a virtual camera using displacement of XYZ-axes, Patent Document 3 does not disclose an operation method combined with screen touch operation.

Meanwhile, there is a hybrid operation method, which is a combination of screen tilt operation and screen touch operation, implemented by an application for omnidirectional video viewing and listening (existing hybrid application) or the like.

However, with an existing hybrid application, in a case where a virtual camera is rotated in a pitch direction by drag operation in a vertical direction at a time of screen touch operation, the sky above or ground below may be inevitably visible even if a user holds a display terminal (such as a smartphone) in a horizontal direction. Therefore, the user may be confused as to which direction the viewpoint is facing.

Note that, with an existing hybrid application, in a case where tilt of a screen of a display terminal is in a yaw rotation or pitch rotation by screen tilt operation, a virtual camera rotates in a yaw direction or pitch direction according to the tilt of the screen. Furthermore, with an existing hybrid application, in a case where drag operation is performed in a transverse direction or vertical direction on a screen with one finger by screen touch operation, a virtual camera rotates in a yaw direction or pitch direction according to an amount of movement of the fingertip.

<3. Configuration of Computer>

The above-described series of processing (such as the display processing in FIG. 10) can be executed by hardware or can be executed by software. In a case where a series of processing is executed by software, a program included in the software is installed on a computer in each device.

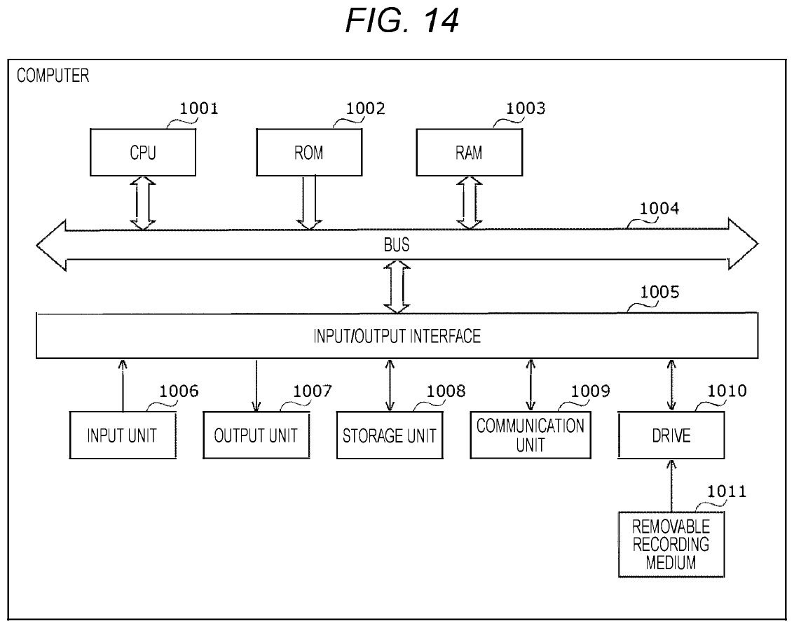

FIG. 14 is a block diagram illustrating an example of a configuration of hardware of a computer that executes the series of processing described above by a program.

In the computer, a central processing unit (CPU) 1001, a read only memory (ROM) 1002, and a random access memory (RAM) 1003 are mutually connected by a bus 1004. Moreover, an input/output interface 1005 is connected to the bus 1004. An input unit 1006, an output unit 1007, a storage unit 1008, a communication unit 1009, and a drive 1010 are connected to the input/output interface 1005.

The input unit 1006 includes a microphone, a keyboard, a mouse, or the like. The output unit 1007 includes a speaker, a display, or the like. The storage unit 1008 includes a hard disk, a non-volatile memory, or the like. The communication unit 1009 includes a network interface, or the like. The drive 1010 drives a removable recording medium 1011 such as a magnetic disk, an optical disk, a magneto-optical disk, or a semiconductor memory.

In the computer configured as above, the series of processing described above is executed by the CPU 1001 loading a program recorded in the ROM1002 or storage unit 1008 to the RAM 1003 via the input/output interface 1005 and the bus 1004 and executing the program.

A program executed by the computer (CPU 1001) can be provided by being recorded on the removable recording medium 1011 as a package medium, or the like, for example. Furthermore, the program can be provided via a wired or wireless transmission medium such as a local area network, the Internet, or digital satellite broadcasting.

In the computer, the program can be installed on the storage unit 1008 via the input/output interface 1005 by attaching the removable recording medium 1011 to the drive 1010. Furthermore, the program can be received by the communication unit 1009 via the wired or wireless transmission medium and installed on the storage unit 1008. In addition, the program can be installed on the ROM 1002 or the storage unit 1008 in advance.

Here, in the present specification, processing performed by a computer according to the program does not necessarily have to be performed in time series in an order described as a flowchart. That is, processing performed by the computer according to a program also includes processing that is executed in parallel or individually (for example, parallel processing or object processing). Furthermore, the program may be processed by one computer (processor) or may be subjected to distributed processing by a plurality of computers.

Note that embodiments of the present technology are not limited to the above-described embodiments, and various changes can be made without departing from the scope of the present technology.

Furthermore, each of the steps in the display processing (FIG. 10) and the image processing (FIG. 11) can be executed by one device, or can be executed by being shared by a plurality of devices. Moreover, in a case where a plurality of pieces of processing is included in one step, the plurality of pieces of processing included in the one step can be executed by being shared by a plurality of devices, in addition to being executed by one device.

Note that the following configurations can be used for the present technology.

(1)

An image processing device including

an image processing unit that

disposes, in a three-dimensional virtual space, a virtual camera that specifies an area in the virtual space, the area being displayed by a display terminal,

performs control so that the display terminal displays a background image representing the virtual space and a virtual object disposed in the background image,

determines pitch rotation of the display terminal on the basis of a measurement signal measured by the display terminal,

causes the virtual camera to rotate in a pitch direction around the virtual object on the basis of a determination result of the pitch rotation of the display terminal,

determines touch operation on a touch panel of the display terminal, and

causes the virtual camera to rotate in a yaw direction around the virtual object in the virtual space on the basis of a determination result of the touch operation.

(2)

The image processing device according to (1),

in which the image processing unit does not reflect the determination result of the touch operation in rotation of the virtual camera in the pitch direction in the virtual space.

(3)

The image processing device according to (1) or (2),

in which the background image includes a wide-angle image having a viewing angle of at least 180 degrees or wider, and

the image processing unit does not reflect an actual position of the display terminal in the real space in movement of the virtual camera.

(4)

The image processing device according to (1),

in which rotation of the virtual camera in the pitch direction and yaw direction includes revolution of the virtual camera around the virtual object.

(5)

The image processing device according to any one of (1) to (4),

in which the image processing unit
determines pitch rotation and yaw rotation of the display terminal on the basis of a measurement signal measured by the display terminal, and
causes the virtual camera to rotate in at least either of the pitch direction or the yaw direction around the virtual object on the basis of a determination result of the pitch rotation and yaw rotation of the display terminal.

(6)

The image processing device according to (2),

in which, in a case where predetermined operation in a horizontal direction is performed on the touch panel as the touch operation, the image processing unit causes the virtual camera to rotate in the yaw direction around the virtual object in the virtual space.

(7)

The image processing device according to (6),

in which, in a case where predetermined operation in a perpendicular direction is performed on the touch panel as the touch operation, the image processing unit does not reflect the touch operation in rotation of the virtual camera in the pitch direction in the virtual space.

(8)

The image processing device according to (7),

in which, in a case where predetermined operation in a perpendicular direction is performed on the touch panel, the image processing unit moves a rotation center of the virtual camera in a Y-axis direction of world coordinates from a current position.

(9)

The image processing device according to (7) or (8),

in which the predetermined operation includes drag operation by a finger of a user.

(10)

The image processing device according to any one of (1) to (3),

in which the measurement signal includes a signal related to three-dimensional angular velocity and acceleration that are measured when the user performs operation to tilt the display terminal.

(11)

The image processing device according to any one of (1) to (10), the image processing device being configured as the display terminal.

(12)

The image processing device according to any one of (1) to (11),

in which the display terminal includes a mobile terminal.

(13)

An image processing method including,

by an image processing device:

disposing, in a three-dimensional virtual space, a virtual camera that specifies an area in the virtual space, the area being displayed by a display terminal;

performing control so that the display terminal displays a background image representing the virtual space and a virtual object disposed in the background image;

determining pitch rotation of the display terminal on the basis of a measurement signal measured by the display terminal;

causing the virtual camera to rotate in a pitch direction around the virtual object on the basis of a determination result of the pitch rotation of the display terminal;

determining touch operation on a touch panel of the display terminal; and

causing the virtual camera to rotate in a yaw direction around the virtual object in the virtual space on the basis of a determination result of the touch operation.

(14)

A program causing a computer to function as an image processing device including

an image processing unit that

disposes, in a three-dimensional virtual space, a virtual camera that specifies an area in the virtual space, the area being displayed by a display terminal,

performs control so that the display terminal displays a background image representing the virtual space and a virtual object disposed in the background image,

determines pitch rotation of the display terminal on the basis of a measurement signal measured by the display terminal,

causes the virtual camera to rotate in a pitch direction around the virtual object on the basis of a determination result of the pitch rotation of the display terminal,

determines touch operation on a touch panel of the display terminal, and

causes the virtual camera to rotate in a yaw direction around the virtual object in the virtual space on the basis of a determination result of the touch operation.

(15)

A recording medium recorded with a program for causing a computer to function as an image processing unit that

disposes, in a three-dimensional virtual space, a virtual camera that specifies an area in the virtual space, the area being displayed by a display terminal,

performs control so that the display terminal displays a background image representing the virtual space and a virtual object disposed in the background image,

determines pitch rotation of the display terminal on the basis of a measurement signal measured by the display terminal,

causes the virtual camera to rotate in a pitch direction around the virtual object on the basis of a determination result of the pitch rotation of the display terminal,

determines touch operation on a touch panel of the display terminal, and

causes the virtual camera to rotate in a yaw direction around the virtual object in the virtual space on the basis of a determination result of the touch operation.

### REFERENCE SIGNS LIST

1 3D image display system
10, 10-1 to 10-N Display terminal
20 Distribution server
30 Network
50 Virtual camera
60 Virtual object
101 Control unit
102 Memory
103 Sensor
104 Image processing unit
105 Storage unit
106 Display unit
107 Input unit
108 Communication unit
110 Touch panel
121 Terminal tilt detection unit
122 Screen touch detection unit
123 Image processing unit
124 Display control unit
1001 CPU

1. An image processing device comprising
an image processing unit that
disposes, in a three-dimensional virtual space, a virtual camera that specifies an area in the virtual space, the area being displayed by a display terminal,
performs control so that the display terminal displays a background image representing the virtual space and a virtual object disposed in the background image,
determines pitch rotation of the display terminal on a basis of a measurement signal measured by the display terminal,
causes the virtual camera to rotate in a pitch direction around the virtual object on a basis of a determination result of the pitch rotation of the display terminal,
determines touch operation on a touch panel of the display terminal, and
causes the virtual camera to rotate in a yaw direction around the virtual object in the virtual space on a basis of a determination result of the touch operation.

2. The image processing device according to claim 1,
wherein the image processing unit does not reflect the determination result of the touch operation in rotation of the virtual camera in the pitch direction in the virtual space.

3. The image processing device according to claim 2,
wherein the background image includes a wide-angle image having a viewing angle of at least 180 degrees or wider, and
the image processing unit does not reflect an actual position of the display terminal in the real space in movement of the virtual camera.

4. The image processing device according to claim 1,
wherein rotation of the virtual camera in the pitch direction and yaw direction includes revolution of the virtual camera around the virtual object.

5. The image processing device according to claim 1,
wherein the image processing unit
determines pitch rotation and yaw rotation of the display terminal on a basis of a measurement signal measured by the display terminal, and
causes the virtual camera to rotate in at least either of the pitch direction or the yaw direction around the virtual object on a basis of a determination result of the pitch rotation and yaw rotation of the display terminal.

6. The image processing device according to claim 2,
wherein, in a case where predetermined operation in a horizontal direction is performed on the touch panel as the touch operation, the image processing unit causes the virtual camera to rotate in the yaw direction around the virtual object in the virtual space.

7. The image processing device according to claim 6,
wherein, in a case where predetermined operation in a perpendicular direction is performed on the touch panel as the touch operation, the image processing unit does not reflect the touch operation in rotation of the virtual camera in the pitch direction in the virtual space.

8. The image processing device according to claim 7,
wherein, in a case where predetermined operation in a perpendicular direction is performed on the touch panel, the image processing unit moves a rotation center of the virtual camera in a Y-axis direction of world coordinates from a current position.

9. The image processing device according to claim 7,
wherein the predetermined operation includes drag operation by a finger of a user.

10. The image processing device according to claim 2,
wherein the measurement signal includes a signal related to three-dimensional angular velocity and acceleration that are measured when the user performs operation to tilt the display terminal.

11. The image processing device according to claim 1, the image processing device being configured as the display terminal.

12. The image processing device according to claim 1,
wherein the display terminal includes a mobile terminal.

13. An image processing method comprising,
by an image processing device:
disposing, in a three-dimensional virtual space, a virtual camera that specifies an area in the virtual space, the area being displayed by a display terminal;
performing control so that the display terminal displays a background image representing the virtual space and a virtual object disposed in the background image;
determining pitch rotation of the display terminal on a basis of a measurement signal measured by the display terminal;
causing the virtual camera to rotate in a pitch direction around the virtual object on a basis of a determination result of the pitch rotation of the display terminal;
determining touch operation on a touch panel of the display terminal; and
causing the virtual camera to rotate in a yaw direction around the virtual object in the virtual space on a basis of a determination result of the touch operation.

14. A recording medium recorded with a program for causing a computer to function as an image processing unit that
disposes, in a three-dimensional virtual space, a virtual camera that specifies an area in the virtual space, the area being displayed by a display terminal,
performs control so that the display terminal displays a background image representing the virtual space and a virtual object disposed in the background image,
determines pitch rotation of the display terminal on a basis of a measurement signal measured by the display terminal,
causes the virtual camera to rotate in a pitch direction around the virtual object on a basis of a determination result of the pitch rotation of the display terminal,
determines touch operation on a touch panel of the display terminal, and
causes the virtual camera to rotate in a yaw direction around the virtual object in the virtual space on a basis of a determination result of the touch operation.
